(19) United States
(12) Patent Application Publication
(10) Pub. No.: US 2023/0176240 A1
(43) Pub. Date: Jun. 8, 2023

(54) RADIATION IMAGING APPARATUS

(71) Applicant: CANON KABUSHIKI KAISHA, Tokyo (JP)

(72) Inventor: SHICHIHEI SAKURAGI, Tokyo (JP)

(21) Appl. No.: 18/060,886

(22) Filed: Dec. 1, 2022

(30) Foreign Application Priority Data
Dec. 8, 2021 (JP) 2021-199304

(51) Int. Cl. G01T 7/00; G01T 1/16; H04N 23/30

(52) U.S. Cl. CPC G01T 7/00; G01T 1/16; H04N 23/30; G01N 23/04; G01N 2223/30

(57) ABSTRACT

A radiation imaging apparatus includes a radiation detector configured to detect radiation and convert the detected radiation into an electrical signal relating to a radiation image, a support base having a rectangular shape and supporting the radiation detector, and a housing accommodating the radiation detector and the support base, wherein the support base includes a plurality of protrusions extending from each side of an outer edge in the rectangular shape toward an inner wall of the housing, and wherein, at an end of a first protrusion located at a corner in the rectangular shape among the plurality of protrusions, a distance to the inner wall of the housing is shorter than at an end of a second protrusion located at a position other than the corner.

### BACKGROUND

### Field of the Disclosure

The present disclosure relates to a radiation imaging apparatus applicable to apparatuses that use radiation, such as a medical-image diagnosis apparatus, a nondestructive inspection apparatus, and an analysis apparatus.

### Description of the Related Art

In the medical field, there is widely used a radiation imaging apparatus that obtains a radiation image based on an intensity distribution of radiation passing through a subject when the subject is irradiated with radiation

In particular, in the present day, a digital radiation imaging apparatus that acquires a digital radiation image is used and a radiation image can be instantly acquired. The digital radiation imaging apparatus has a housing, and includes a radiation detector in the housing. In the radiation detector, light emitted by a fluorescent member based on radiation is detected using a semiconductor sensor, and the detected light is converted into an electrical signal relating to a radiation image.

In addition, in recent years, there has been developed a portable radiation imaging apparatus that can be carried by a camera operator, by being reduced in weight and thickness so that radiography of a subject in arbitrary posture can be performed. However, because the subject gets directly on the portable radiation imaging apparatus depending on the photography situation, the portable radiation imaging apparatus can directly receive a load by the weight of the subject, or can be dropped by mistake while being handled. Therefore, the portable radiation imaging apparatus is expected to have a structure that absorbs and disperses an impact, in order to prevent an internal radiation detector from being damaged by a load received from outside or a drop impact.

Japanese Patent Application Laid-Open No. 2018-84484 discusses a structure in which an outer edge portion of a support base supporting a radiation detector is provided with an abutting portion that abuts the inner side of a side wall portion of a housing, and a rear end, which is opposite to a front end abutting the side wall portion, of the abutting portion is thicker than other portions. Further, Japanese Patent Application Laid-Open No. 2018-84484 discusses a structure in which a corner of the support base is shaped to be more backward than outer edge portions on both sides connecting to the corner, so that an impact to be received by the corner is avoided.

In the above-described technique discussed in Japanese Patent Application Laid-Open No. 2018-84484, the inner side of the side wall portion of the housing and the abutting portion directly abut on each other, and therefore, a drop impact is directly transmitted to the support base. To address this issue, in Japanese Patent Application Laid-Open No. 2018-84484, impact resistance is improved by providing the rear end of the abutting portion with the thick portion. However, in this technique of Japanese Patent Application Laid-Open No. 2018-84484, it is necessary to provide a space dedicated to the thick portion in the inside of the radiation imaging apparatus, and it is also necessary to have a large and thick structure so that the front end of the abutting portion also withstands the directly applied impact.

Meanwhile, a radiation imaging apparatus falls on a corner of a housing first in many cases. In such a case, the radiation imaging apparatus can be damaged or form a crack due to an impact applied to the corner of the housing. Japanese Patent Application Laid-Open No. 2018-84484 described above discusses forming, at the corner of the support base, the portion shaped to be more backward than the front end surfaces of the outer edge portions on both sides connecting to the corner, or providing a chamfer at the corner of the support base, as a measure against the impact received by the corner. Here, in a case where the internal radiation detector is damaged by falling on a corner of the housing, this damage occurs due to the corner of the support base colliding with the inside of the corner of the housing. This collision is caused by two phenomena; the support base inside the housing rapidly moves toward the corner of the housing due to the inertial force in the fall, and the corner itself of the housing is deformed toward the support base by the impact force. In a case where the corner of the support base is made more backward than the other outer edge portions to avoid these two phenomena, it is necessary to have a long distance between the corner of the housing and the corner of the support base. However, the size of a radiation imaging apparatus is specified according to the standards for medical equipment of each country, and therefore, the above-described structures both lead to a reduction in the size of the support base, which results in a factor for reducing an effective pixel region in radiography.

Therefore, the portable radiation imaging apparatus is expected to have a structure that protects the internal radiation detector by efficiently absorbing and dispersing the impact in a limited inner space, when the housing receives the impact from outside.

### SUMMARY

Aspects of the present disclosure provide for a radiation imaging apparatus that can protect an internal radiation detector, by efficiently absorbing and dispersing an impact in a limited inner space, when a housing receives the impact from outside.

According to an aspect of the present disclosure, a radiation imaging apparatus includes a radiation detector configured to detect radiation and convert the detected radiation into an electrical signal relating to a radiation image, a support base having a rectangular shape and supporting the radiation detector, and a housing accommodating the radiation detector and the support base, wherein the support base includes a plurality of protrusions extending from each side of an outer edge in the rectangular shape toward an inner wall of the housing, and wherein, at an end of a first protrusion located at a corner in the rectangular shape among the plurality of protrusions, a distance to the inner wall of the housing is shorter than at an end of a second protrusion located at a position other than the corner.

According to another aspect of the present disclosure, a radiation imaging apparatus includes a radiation detector configured to detect radiation and convert the detected radiation into an electrical signal relating to a radiation image, a support base having a rectangular shape and supporting the radiation detector, and a housing accommodating the radiation detector and the support base, wherein the support base includes a plurality of protrusions extending from each side of an outer edge in the rectangular shape toward an inner wall of the housing, and wherein, among the plurality of protrusions, a first protrusion located at a corner in the rectangular shape has rigidity greater than rigidity of a second protrusion located at a position other than the corner.

Further features of the present disclosure will become apparent from the following description of exemplary embodiments with reference to the attached drawings.

### BRIEF DESCRIPTION OF THE DRAWINGS

FIG. 1 is a diagram illustrating an example of a schematic configuration of a radiation imaging apparatus according to a first exemplary embodiment of the present disclosure.

FIG. 2 is an enlarged cross-sectional view of an outer edge portion (e.g., a right end) and its vicinity of the radiation imaging apparatus illustrated in FIG. 1.

FIG. 3 is an enlarged view of a corner (e.g., a lower left corner) and its vicinity of the radiation imaging apparatus illustrated in FIG. 1.

FIG. 4 is a diagram illustrating a state where the corner illustrated in FIG. 3 of an outer casing of the radiation imaging apparatus has collided with an obstacle after falling on the corner in a falling direction.

FIGS. 5A and 5B are diagrams illustrating a state where a side of the outer casing of the radiation imaging apparatus illustrated in FIG. 1 has collided with an obstacle after falling on the side in a falling direction.

FIG. 6 is an enlarged view of the corner (e.g., the lower left corner) and its vicinity of the radiation imaging apparatus illustrated in FIG. 1.

FIG. 7 is an enlarged view of the corner (e.g., the lower left corner) and its vicinity of the radiation imaging apparatus illustrated in FIG. 1.

FIG. 8 is a diagram illustrating an example of a schematic configuration of a radiation imaging apparatus according to a second exemplary embodiment of the present disclosure.

FIG. 9 is an enlarged view of a corner (e.g., a lower left corner) and its vicinity of the radiation imaging apparatus illustrated in FIG. 8.

FIG. 10 is a diagram illustrating an example of a schematic configuration of a radiation imaging apparatus according to a third exemplary embodiment of the present disclosure.

FIG. 11 is an enlarged view of a corner (e.g., a lower left corner) and its vicinity of the radiation imaging apparatus illustrated in FIG. 10.

FIG. 12 is an enlarged view of the corner (e.g., the lower left corner) and its vicinity of the radiation imaging apparatus illustrated in FIG. 10.

FIG. 13 is an enlarged view of a corner (e.g., a lower left corner) and its vicinity of a radiation imaging apparatus according to a fourth exemplary embodiment of the present disclosure.

### DESCRIPTION OF THE EMBODIMENTS

Modes (exemplary embodiments) for carrying out the present disclosure will be described below with reference to the drawings. Through each of the exemplary embodiments of the present disclosure to be described below, similar components are denoted by the same reference numerals.

First, a first exemplary embodiment of the present disclosure will be described.

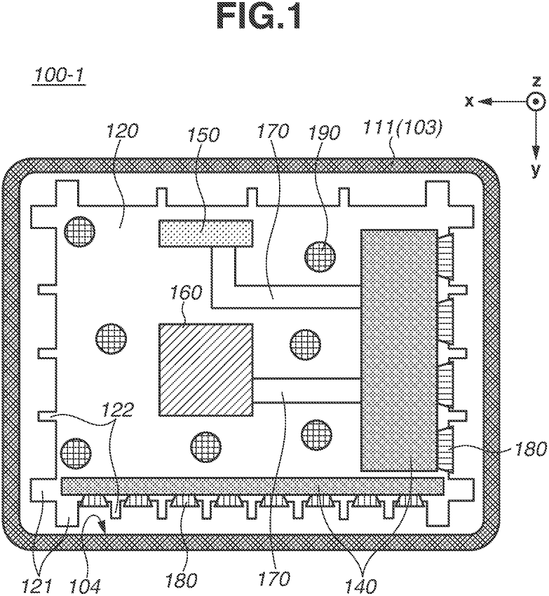

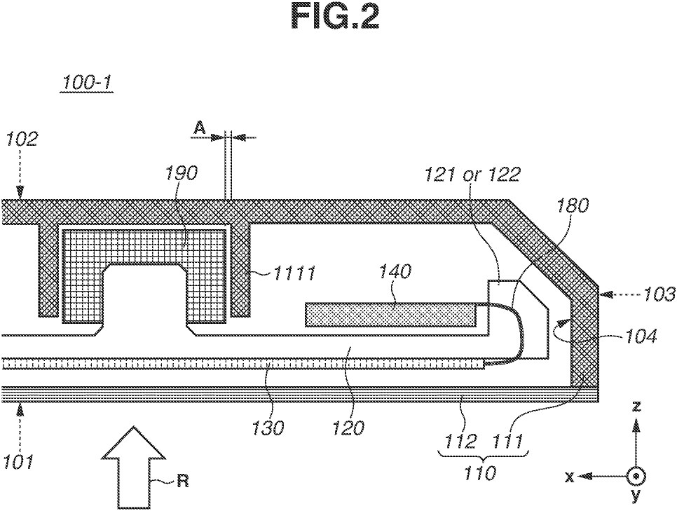

FIG. 1 is a diagram illustrating an example of a schematic configuration of a radiation imaging apparatus 100-1 according to the first exemplary embodiment of the present disclosure. Specifically, FIG. 1 is a perspective view of the inside of the radiation imaging apparatus 100-1 when the inside is viewed from a rear surface portion located opposite to an incidence surface portion on which radiation is to be incident in a housing of the radiation imaging apparatus 100-1. FIG. 1 illustrates an xyz coordinate system, in which a direction in which radiation is incident is a z-direction (in FIG. 2 to be described below, a direction in which radiation R indicated by a white arrow is incident is the z-direction), and two directions orthogonal to the z-direction and orthogonal to each other are an x-direction and a y-direction. In other words, FIG. 1 illustrates an example of a schematic configuration of the radiation imaging apparatus 100-1 in an xy plane.

FIG. 2 is an enlarged cross-sectional view of an outer edge portion (e.g., a right end) and its vicinity of the radiation imaging apparatus 100-1 illustrated in FIG. 1. Here, in FIG. 2, each configuration similar to the configuration illustrated in FIG. 1 is denoted by the same reference numeral as that in FIG. 1. In addition, FIG. 2 illustrates an xyz coordinate system corresponding to the xyz coordinate system illustrated in FIG. 1. In other words, FIG. 2 illustrates an example of a schematic configuration of the radiation imaging apparatus 100-1 in an xz plane.

A schematic configuration of the radiation imaging apparatus 100-1 will be described below with reference to FIG. 1 and FIG. 2.

As illustrated in FIG. 1 and FIG. 2, the radiation imaging apparatus 100-1 includes a housing 110, a support base 120, a radiation detector 130, a control board 140, a communication board 150, a battery 160, wiring 170, flexible wiring 180, and an impact receiving portion 190.

The housing 110 accommodates the support base 120, the radiation detector 130, the control board 140, the communication board 150, the battery 160, the wiring 170, the flexible wiring 180, and the impact receiving portion 190. As illustrated in FIG. 2, the housing 110 includes a radiation incidence board 112 forming an incidence surface portion 101 on the side where the radiation R is to be incident, and an outer casing 111 forming a rear surface portion 102 located opposite to the incidence surface portion 101 and a side wall portion 103 connecting the incidence surface portion 101 and the rear surface portion 102. Because FIG. 1 is the perspective view of the inside of the radiation imaging apparatus 100-1 when the inside is viewed from the rear surface portion 102 of the housing 110, only the side wall portion 103 of the outer casing 111 is illustrated.

The radiation detector 130 illustrated in FIG. 2 detects the incident radiation R (including the radiation R that has passed through a subject), and converts the detected radiation R into an electrical signal relating to a radiation image.

The support base 120 supports the radiation detector 130. Specifically, the support base 120 supports the radiation detector 130 on the side where the rear surface portion 102 opposite to the incidence surface portion 101 is located in the housing 110, as illustrated in FIG. 2. To be more specific, the support base 120 is fixed to be integral with the radiation detector 130, and supports the radiation detector 130.

Further, as illustrated in FIG. 1, the support base 120 has a rectangular shape, and includes a plurality of corner convex portions 121 and a plurality of side convex portions 122 corresponding to a plurality of protrusions extending from each side of an outer edge in this rectangular shape toward an inner wall 104 of the outer casing 111 of the housing 110. Here, among the plurality of protrusions included in the support base 120, the corner convex portion 121 is a first protrusion located at a corner in the rectangular shape of the support base 120. Further, among the plurality of protrusions included in the support base 120, the side convex portion 122 is a second protrusion located at a position other than the corner in the rectangular shape of the support base 120. The corner convex portion 121 and the side convex portion 122 project from an outer edge of the support base 120 to face the side wall portion 103 of the outer casing 111, by a projection amount for avoiding being contact with the side wall portion 103. In the example illustrated in FIG. 1, the corner convex portion 121 (the first protrusion) has a larger amount of projection from the support base 120 than that of the side convex portion 122 (the second protrusion). Therefore, in the present exemplary embodiment, at an end of the corner convex portion 121 (the first protrusion), the distance to the inner wall 104 of the outer casing 111 forming the side wall portion 103 of the housing 110 is shorter than at an end of the side convex portion 122 (the second protrusion), as illustrated in FIG. 1.

The control board 140, the communication board 150, and the battery 160 are disposed on the rear surface portion 102 side of the support base 120, as illustrated in FIG. 1. Boards such as the control board 140 and the communication board 150 and the battery 160 are electrically connected by the wiring 170. Further, as illustrated in FIG. 2, the radiation detector 130 and the control board 140 are connected by the flexible wiring 180 wrapping around the outer edge of the support base 120. The radiation imaging apparatus 100-1 is driven by electrical energy supplied from an external power source or the internal battery 160. The radiation detector 130 detects the radiation R incident via the radiation incidence board 112 illustrated in FIG. 2, converts the detected radiation R into an electrical signal relating to a radiation image which is image information, and outputs the electrical signal relating to the radiation image to the control board 140 via the flexible wiring 180. The control board 140 outputs the electrical signal relating to the radiation image, which is the image information, to an external device by wire or wirelessly. This is the basic structure of the radiation imaging apparatus 100-1.

Further, in the present exemplary embodiment, on the rear surface portion 102 side of the support base 120, the plurality of impact receiving portions 190 is disposed in a space where various boards, various wiring lines, the battery 160, and the like are not disposed, as illustrated in FIG. 1. As illustrated in FIG. 2, the impact receiving portion 190 has an engaging structure with a vertical wall 1111 of the outer casing 111, and there is a gap A between the impact receiving portion 190 and the vertical wall 1111 of the outer casing 111.

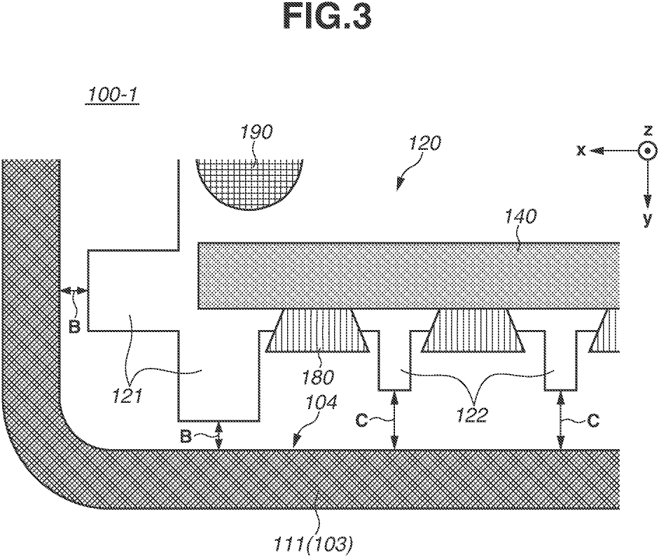

FIG. 3 is an enlarged view of a corner (e.g., a lower left corner) and its vicinity of the radiation imaging apparatus 100-1 illustrated in FIG. 1. Here, in FIG. 3, each configuration similar to the configuration illustrated in FIG. 1 and FIG. 2 is denoted by the same reference numeral as that in FIG. 1 and FIG. 2. In addition, FIG. 3 illustrates an xyz coordinate system corresponding to the xyz coordinate system illustrated in FIG. 1 and FIG. 2.

In the radiation imaging apparatus 100-1 according to the present exemplary embodiment, there is a gap B between the corner convex portion 121 and the inner wall 104 of the outer casing 111 forming the side wall portion 103 of the housing 110, as illustrated in FIG. 3. In addition, in the radiation imaging apparatus 100-1 according to the present exemplary embodiment, there is a gap C between the side convex portion 122 and the inner wall 104 of the outer casing 111 forming the side wall portion 103 of the housing 110, as illustrated in FIG. 3. In the radiation imaging apparatus 100-1 according to the present exemplary embodiment, the gap A illustrated in FIG. 2, the gap B, and the gap C both illustrated in FIG. 3 have a size relationship of gap A < gap B < gap C.

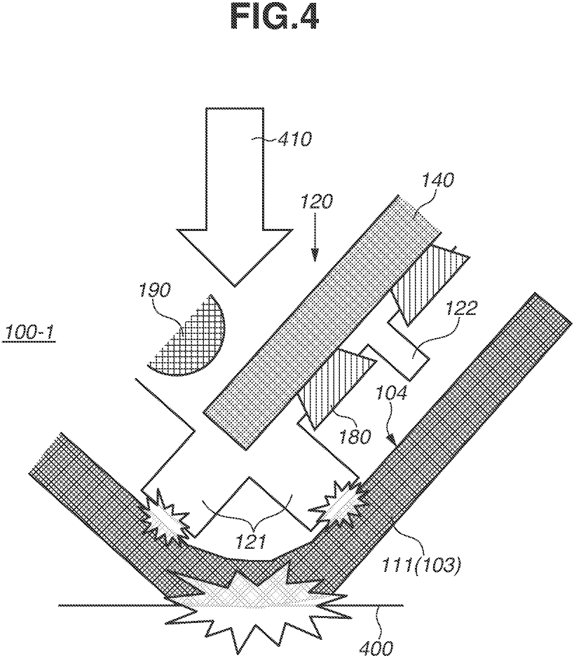

In the radiation imaging apparatus 100-1 thus configured according to the present exemplary embodiment, in a case where a worker such as a camera operator drops the radiation imaging apparatus 100-1 by mistake, the housing 110 first receives the impact thereof. Subsequently, due to the inertial force of the drop, the support base 120 rapidly moves toward a portion such as a corner of the housing 110. In this case, because gap A (the distance between the impact receiving portion 190 and the housing 110) < gap B (the distance between the corner convex portion 121 and the housing 110), the impact received by the housing 110 due to the drop is first transmitted to the impact receiving portion 190. Subsequently, upon receiving this impact force, the impact receiving portion 190 deforms in a compression direction, and further, the corner and its vicinity of the housing 110 also receive the impact force, because a rectangular structure generally falls on the corner first. Therefore, in a case where the impact force of the drop is excessive, mainly the corner and its vicinity of the housing 110 deform inward, and subsequently, the corner convex portion 121 comes in contact with the housing 110 because gap B < gap C, as illustrated in FIG. 4. At this moment, the gap B corresponds to the distance between the corner convex portion 121 and the housing 110, and the gap C corresponds to the distance between the side convex portion 122 and the housing 110. FIG. 4 is a diagram illustrating a state where the corner and its vicinity illustrated in FIG. 3 of the outer casing 111 of the radiation imaging apparatus 100-1 has collided with an obstacle 400 after falling on the corner first in a falling direction 410. Here, in FIG. 4, each configuration similar to the configuration illustrated in FIG. 3 is denoted by the same reference numeral as that in FIG. 3. Specifically, FIG. 4 illustrates a state where the corner convex portion 121 is in contact with the inner wall 104 of the outer casing 111 forming the side wall portion 103 of the housing 110.

In the fall illustrated in FIG. 4, the impact is first received by the impact receiving portion 190, and further, a surplus impact is received by the corner convex portion 121, in the radiation imaging apparatus 100-1. Providing the radiation imaging apparatus 100-1 with such a structure can reduce the drop impact on the radiation detector 130.

The radiation imaging apparatus 100-1 can fall while keeping stability without falling corner first, or can fall toward a corner of an object shaped like a step such as a stair or a desk, even though such a case is rare. In such a case, the radiation imaging apparatus 100-1 can receive an impact at a side.

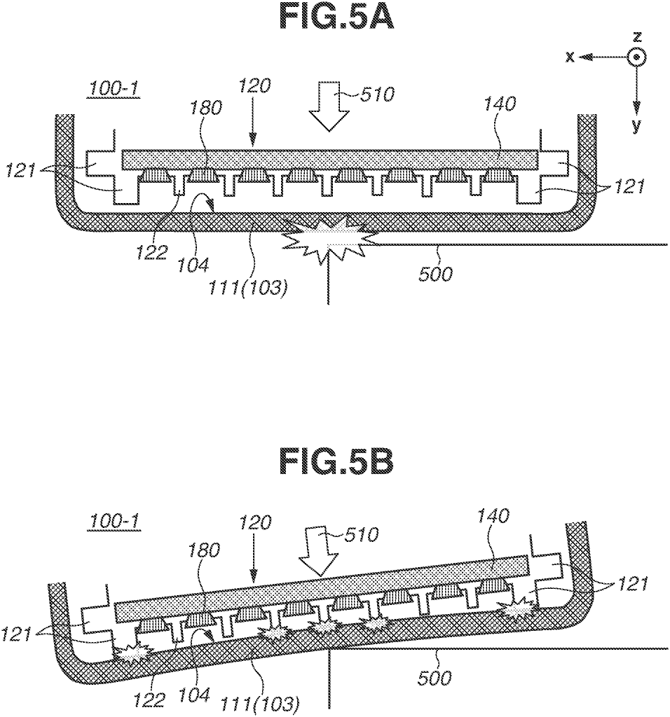

In such a case, due to the inertial force in the fall, the support base 120 and the radiation detector 130 also move toward the side wall portion 103 of the housing 110, and the entire side of the side wall portion 103 of the housing 110 deforms inward. FIGS. 5A and 5B are diagrams illustrating a state where a side of the outer casing 111 of the radiation imaging apparatus 100-1 illustrated in FIG. 1 collides with an obstacle 500 after falling on the side first in a falling direction 510. Here, in FIGS. 5A and 5B, each configuration similar to the configuration illustrated in FIG. 1 is denoted by the same reference numeral as that in FIG. 1. In addition, FIG. 5A illustrates an xyz coordinate system corresponding to the xyz coordinate system illustrated in FIG. 1 and FIG. 2. In the state of the collision illustrated in FIG. 5A, the impact receiving portion 190 first receives the impact thereof, subsequently the corner convex portion 121 receives an impact as illustrated in FIG. 5B, and further, the side convex portion 122 also receives an impact due to deformation of the side of the outer casing 111. Specifically, FIG. 5B illustrates a state where the corner convex portion 121 is in contact with the inner wall 104 of the outer casing 111 forming the side wall portion 103 of the housing 110. Even in a case where the side of the outer casing 111 is deformed by receiving the impact, the drop impact on the radiation detector 130 can be reduced by the receipt of the impact by the side convex portion 122.

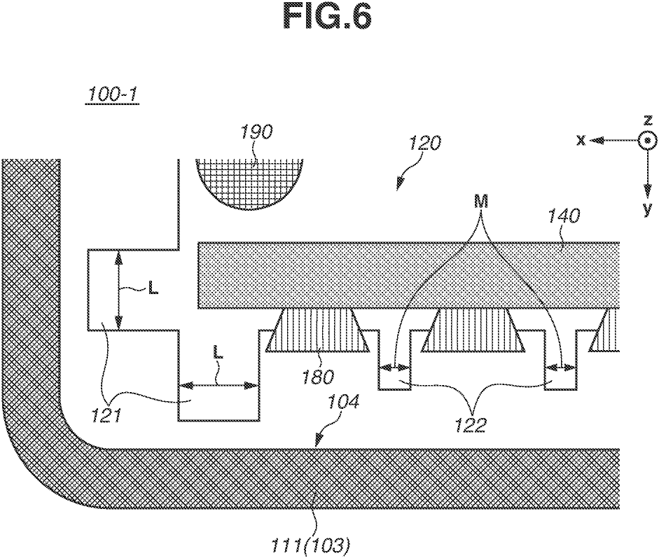

In the present exemplary embodiment, in a case where both of the corner convex portion 121 and the side convex portion 122 receive the drop impact as illustrated in FIG. 5B, the impact received by the corner convex portion 121 is greater because the corner convex portion 121 receives the impact earlier, when the impacts received by the respective portions are compared. Therefore, the corner convex portion 121 is expected to have greater resistance to a drop impact than the side convex portion 122. Here, as a mode in which the impact resistance of the corner convex portion 121 is greater than the impact resistance of the side convex portion 122 (a mode in which the rigidity of the corner convex portion 121 is greater than the rigidity of the side convex portion 122), for example, a mode in which the shape of the side convex portion 122 and the shape of the corner convex portion 121 are different may be adopted. Specifically, to disperse an impact stress received from the side wall portion 103 of the outer casing 111, a mode in which an area to be in contact with the side wall portion 103 of the outer casing 111 is larger in the corner convex portion 121 than in the side convex portion 122 can be adopted, as illustrated in FIG. 6.

FIG. 6 is an enlarged view of the corner and its vicinity (e.g., the lower left corner) of the radiation imaging apparatus 100-1 illustrated in FIG. 1. Here, in FIG. 6, each configuration similar to the configuration illustrated in FIG. 1 to FIG. 3 is denoted by the same reference numeral as that in FIG. 1 to FIG. 3. In addition, FIG. 6 illustrates an xyz coordinate system corresponding to the xyz coordinate system illustrated in FIG. 1 to FIG. 3. Specifically, in FIG. 6, the shape of the corner convex portion 121 and the shape of the side convex portion 122 are made different to satisfy the relationship of width L > width M, where L represents the width of the corner convex portion 121 and M represents the width of the side convex portion 122. In other words, in FIG. 6, in the corner convex portion 121 (the first protrusion), the area of a surface facing the inner wall 104 of the outer casing 111 forming the side wall portion 103 of the housing 110 is larger than in the side convex portion 122 (the second protrusion).

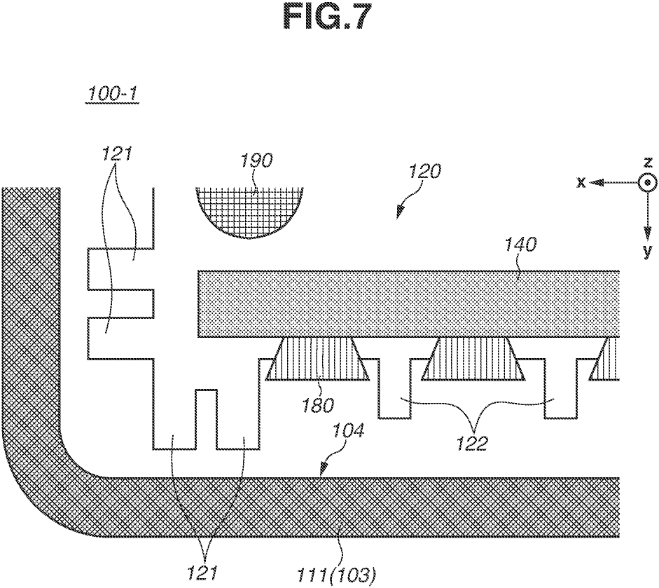

In the present exemplary embodiment, the plurality of corner convex portions 121 may be formed at each corner (and its vicinity) in the rectangular shape of the support base 120. FIG. 7 is an enlarged view of the corner (e.g., the lower left corner) and its vicinity of the radiation imaging apparatus 100-1 illustrated in FIG. 1. Here, in FIG. 7, each configuration similar to the configuration illustrated in FIG. 1 to FIG. 3 is denoted by the same reference numeral as that in FIG. 1 to FIG. 3. In addition, FIG. 7 illustrates an xyz coordinate system corresponding to the xyz coordinate system illustrated in FIG. 1 to FIG. 3. Specifically, in FIG. 7, the plurality of corner convex portions 121 is provided at the corner (and its vicinity) in the rectangular shape of the support base 120.

In the radiation imaging apparatus 100-1 according to the first exemplary embodiment described above, the support base 120 includes the plurality of corner convex portions 121 and the plurality of side convex portions 122 corresponding to the plurality of protrusions extending from each side of the outer edge in the rectangular shape toward the inner wall 104 of the housing 110. Further, in the radiation imaging apparatus 100-1 according to the first exemplary embodiment, at the end of the corner convex portion 121 (the first protrusion), the distance to the inner wall 104 of the outer casing 111 forming the side wall portion 103 of the housing 110 is shorter than at the end of the side convex portion 122 (the second protrusion).

According to such a configuration, when the housing 110 receives an impact (e.g., an impact by a drop) from outside, the impact is efficiently absorbed and dispersed in a limited inner space of the housing 110, so that the internal radiation detector 130 can be protected.

To be more specific, in falling on the corner of the housing 110, which is the main phenomenon at the time of a drop that is one factor of the impact received by the housing 110 from outside, the corner convex portion 121 receives the impact after the impact receiving portion 190 receives the impact, as described above. This makes it possible to reduce the impact at the time of the drop, without reducing the size of each of the support base 120 and the radiation detector 130. Further, even in a case where an impact is received by falling on the side of the housing 110, while such a case is rare, the side convex portion 122 receives only a surplus of the impact received by the impact receiving portion 190 and the corner convex portion 121, so that the impact received by the outer edge of the support base 120 can be reduced. For example, even in a case where the radiation imaging apparatus 100-1 is used as a portable radiation imaging apparatus, it is possible to efficiently absorb and disperse an impact using the housing 110 which is thin and small, while enabling radiography in a large screen based on the size of the radiation detector 130.

Next, a second exemplary embodiment of the present disclosure will be described. In the following description of the second exemplary embodiment, description of matters common to the first exemplary embodiment described above will be omitted, and matters different from the first exemplary embodiment will be mainly described.

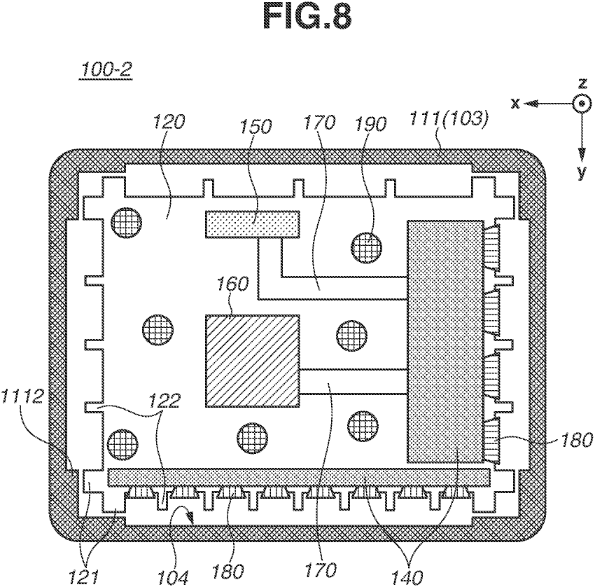

FIG. 8 is a diagram illustrating an example of a schematic configuration of a radiation imaging apparatus 100-2 according to the second exemplary embodiment of the present disclosure. Specifically, FIG. 8 is a perspective view of the inside of the radiation imaging apparatus 100-2 when the inside is viewed from a rear surface portion located opposite to an incidence surface portion on which radiation is to be incident in a housing of the radiation imaging apparatus 100-2. Here, in FIG. 8, each configuration similar to the configuration illustrated in FIG. 1 is denoted by the same reference numeral as that in FIG. 1. In addition, FIG. 8 illustrates an xyz coordinate system corresponding to the xyz coordinate system illustrated in FIG. 1.

Further, an enlarged cross-sectional view of an outer edge portion (e.g., a right end) and its vicinity of the radiation imaging apparatus 100-2 illustrated in FIG. 8 is similar to the outer edge portion (e.g., the right end) and its vicinity illustrated in FIG. 2 of the radiation imaging apparatus 100-1 according to the first exemplary embodiment.

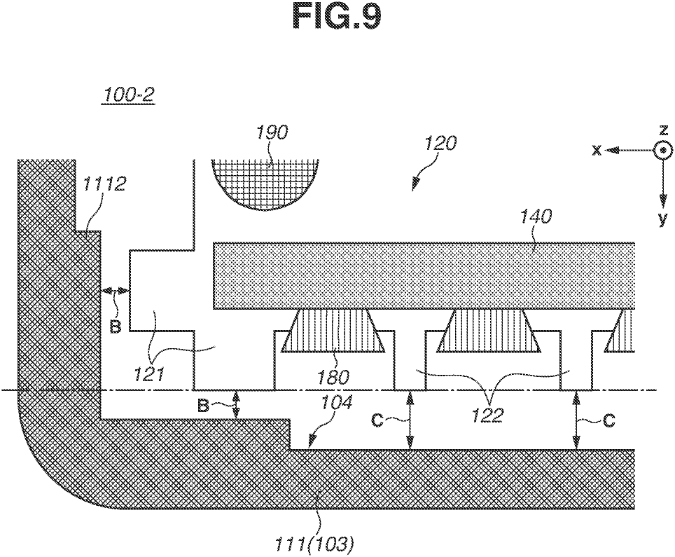

FIG. 9 is an enlarged view of a corner (e.g., a lower left corner) and its vicinity of the radiation imaging apparatus 100-2 illustrated in FIG. 8. Here, in FIG. 9, each configuration similar to the configuration illustrated in FIG. 8 and FIG. 2 is denoted by the same reference numeral as that in FIG. 8 and FIG. 2. In addition, FIG. 9 illustrates an xyz coordinate system corresponding to the xyz coordinate system illustrated in FIG. 8 and FIG. 2.

In the first exemplary embodiment, there is described the mode in which the amount of projection from each side in the rectangular shape of the support base 120 is larger in the corner convex portion 121 than in the side convex portion 122. However, the projection amount of the corner convex portion 121 and the projection amount of the side convex portion 122 may be equal as illustrated in FIG. 8 and FIG. 9. Specifically, in the second exemplary embodiment, as illustrated in FIG. 8 and FIG. 9, a projection portion 1112, which is formed by a portion near the corner convex portion 121 projecting toward a corner convex portion 121, is formed in an inner wall 104 of an outer casing 111 forming a side wall portion 103 of a housing 110. In other words, in the second exemplary embodiment, as illustrated in FIG. 8 and FIG. 9, the projection portion 1112, which is formed by a portion of the inner wall 104 of the outer casing 111 near the corner convex portion 121 (the first protrusion) projecting toward the corner convex portion 121, is formed. Further, in the second exemplary embodiment as well, the relationship of gap B (the distance between the corner convex portion 121 and the housing 110) < gap C (the distance between a side convex portion 122 and the housing 110) is established as illustrated in FIG. 9, as with the first exemplary embodiment described above.

In the second exemplary embodiment, an effect equivalent to that of the first exemplary embodiment described above can be obtained by forming the projection portion 1112 in the inner wall 104 of the outer casing 111 forming the side wall portion 103 of the housing 110. Moreover, in the second exemplary embodiment, the thickness of the side wall portion 103 is large at the corner of the outer casing 111 forming the side wall portion 103 of the housing 110, so that an effect of improving the rigidity of the corner of the housing 110 can also be obtained. In other words, in the second exemplary embodiment, deformation near the corner of the housing 110 caused by an impact received in falling on the corner of the housing 110 is smaller than in the first exemplary embodiment described above, and thus the impact received by the corner convex portion 121 is smaller than in the first exemplary embodiment. The above-described effects make it possible to reinforce the protection of the internal radiation detector 130 further, by efficiently absorbing and dispersing the impact in a limited inner space of the housing 110, when the housing 110 receives the impact (e.g., an impact by a drop) from outside.

The second exemplary embodiment may be combined with the first exemplary embodiment described above. For example, the following mode is conceivable as the combination of the first exemplary embodiment and the second exemplary embodiment. At some corner of the housing 110, the projection amount of the corner convex portion 121 is made larger than the projection amount of the side convex portion 122 as in the first exemplary embodiment. At some other corner of the housing 110, while the projection amount of the corner convex portion 121 and the projection amount of the side convex portion 122 are equal, the projection portion 1112 is formed in the inner wall 104 of the housing 110 as in the second exemplary embodiment.

Next, a third exemplary embodiment of the present disclosure will be described. In the following description of the third exemplary embodiment, description of matters common to the first and second exemplary embodiments described above will be omitted, and matters different from the first and second exemplary embodiments will be mainly described.

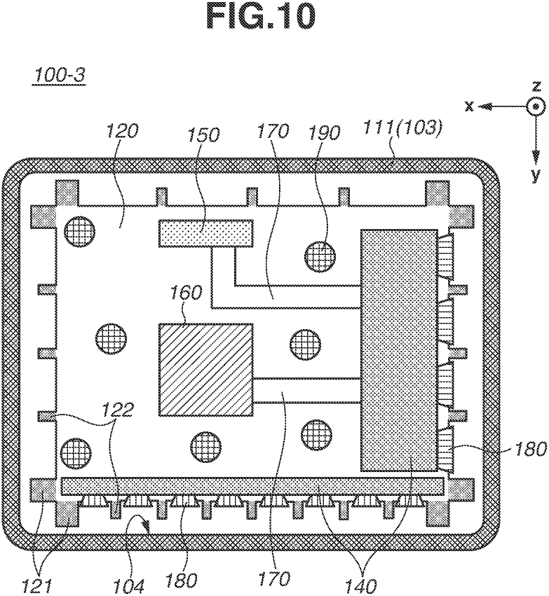

FIG. 10 is a diagram illustrating an example of a schematic configuration of a radiation imaging apparatus 100-3 according to the third exemplary embodiment of the present disclosure. Specifically, FIG. 10 is a perspective view of the inside of the radiation imaging apparatus 100-3 when the inside is viewed from a rear surface portion located opposite to an incidence surface portion on which radiation is to be incident in a housing of the radiation imaging apparatus 100-3. Here, in FIG. 10, each configuration similar to the configuration illustrated in FIG. 1 and FIG. 8 is denoted by the same reference numeral as that in FIG. 1 and FIG. 8. In addition, FIG. 10 illustrates an xyz coordinate system corresponding to the xyz coordinate system illustrated in FIG. 1 and FIG. 8.

Further, an enlarged cross-sectional view of an outer edge portion (e.g., a right end) and its vicinity of the radiation imaging apparatus 100-3 illustrated in FIG. 10 is similar to the outer edge portion (e.g., the right end) and its vicinity illustrated in FIG. 2 of the radiation imaging apparatus 100-1 according to the first exemplary embodiment.

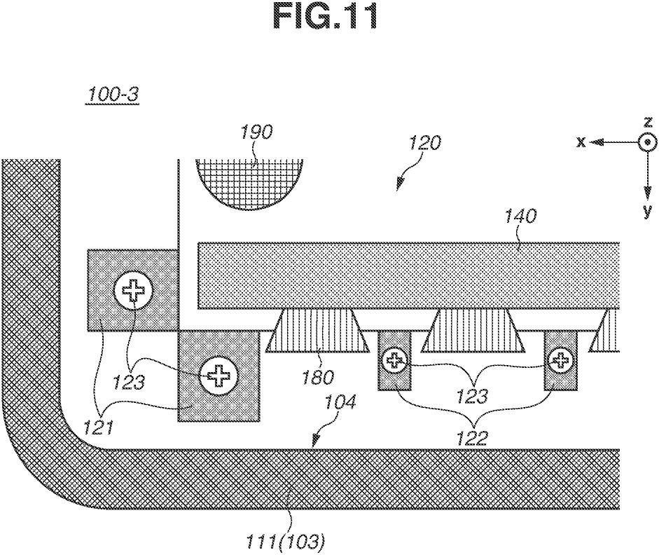

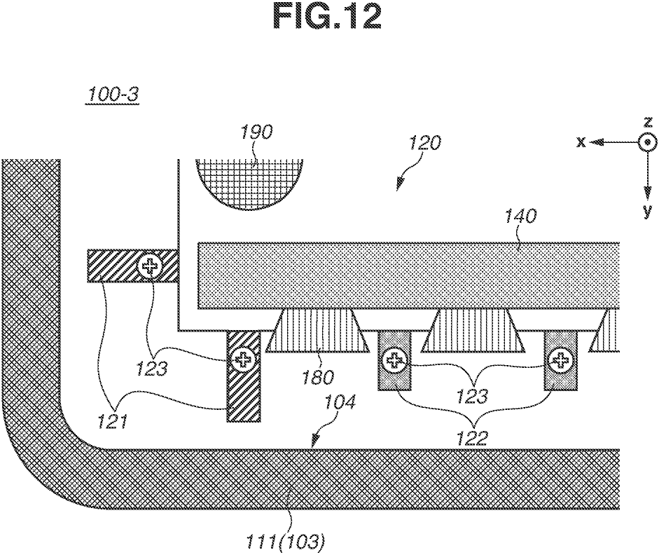

FIG. 11 and FIG. 12 are enlarged views of a corner (e.g., a lower left corner) and its vicinity of the radiation imaging apparatus 100-3 illustrated in FIG. 10. Here, in FIG. 11 and FIG. 12, each configuration similar to the configuration illustrated in FIG. 10 and FIG. 2 is denoted by the same reference numeral as that in FIG. 10 and FIG. 2. In addition, FIG. 11 and FIG. 12 illustrate an xyz coordinate system corresponding to the xyz coordinate system illustrated in FIG. 10 and FIG. 2.

In the first exemplary embodiment described above, the mode in which the corner convex portion 121 and the side convex portion 122 are integral with the support base 120 is described, but the corner convex portion 121 and the side convex portion 122 may be separate from the support base 120 as illustrated in FIG. 10 to FIG. 12.

A support base 120 is configured using, for example, an aluminum alloy, a magnesium alloy, or a fiber-reinforced resin such as carbon fiber-reinforced plastic (CFRP), as a main material. In the present exemplary embodiment, for a corner convex portion 121 and a side convex portion 122 provided separately from the support base 120, an elastic resin material such as rubber or elastomer may be used as the main material, or engineering plastic such as polyoxymethylene (POM), polycarbonate (PC), acrylonitrile-butadiene-styrene (ABS), or Monocast (MC) nylon may be used as the main material.

As illustrated in FIG. 11 and FIG. 12, the support base 120, the corner convex portion 121, and the side convex portion 122 may be fastened by screws 123. Further, the support base 120, the corner convex portion 121, and the side convex portion 122 may be bonded by an adhesive or adhesive tape (not illustrated).

While the example in which the corner convex portion 121 and the side convex portion 122 are made of the same material is illustrated in FIG. 10 and FIG. 11, the material of the corner convex portion 121 and the material of the side convex portion 122 may be different as illustrated in FIG. 12. In each of the first and second exemplary embodiments and the mode illustrated in FIG. 10 and FIG. 11 described above, the shape of the corner convex portion 121 is wider than the shape of the side convex portion 122 in the xy plane, and the rigidity of the corner convex portion 121 is greater than that of the side convex portion 122. In contrast, in the mode illustrated in FIG. 12, the rigidity of the corner convex portion 121 is made to be greater than that of the side convex portion 122, by using a material more rigid than the material of the side convex portion 122, for the corner convex portion 121. In this way, the rigidity of the corner convex portion 121 is made to be greater than that of the side convex portion 122, so that the corner convex portion 121 that receives a greater impact by a drop can have higher impact resistance than that of the side convex portion 122. This makes it possible to protect an internal radiation detector 130, by efficiently absorbing and dispersing the impact in a limited inner space of a housing 110, when the housing 110 receives the impact (e.g., an impact by a drop) from outside, as with the first exemplary embodiment described above.

The third exemplary embodiment may be combined with the first exemplary embodiment and the second exemplary embodiment. For example, the following mode is conceivable as the combination of the first exemplary embodiment, the second exemplary embodiment, and the third exemplary embodiment. Some corner convex portion 121 and side convex portion 122 are integral with the support base 120 as in the first exemplary embodiment and the second exemplary embodiment, and some other corner convex portion 121 and side convex portion 122 are separately provided from the support base 120 as in the third exemplary embodiment.

Next, a fourth exemplary embodiment of the present disclosure will be described. In the following description of the fourth exemplary embodiment, description of matters common to the first to third exemplary embodiments described above will be omitted, and matters different from the first to third exemplary embodiments will be mainly described.

A schematic configuration of a radiation imaging apparatus 100-4 according to the fourth exemplary embodiment is similar to, for example, the schematic configuration of the radiation imaging apparatus 100-1 according to the first exemplary embodiment illustrated in FIG. 1. Further, an enlarged cross-sectional view of an outer edge portion (e.g., a right end) and its vicinity of the radiation imaging apparatus 100-4 according to the fourth exemplary embodiment is similar to the outer edge portion (e.g., the right end) and its vicinity illustrated in FIG. 2 of the radiation imaging apparatus 100-1 according to the first exemplary embodiment.

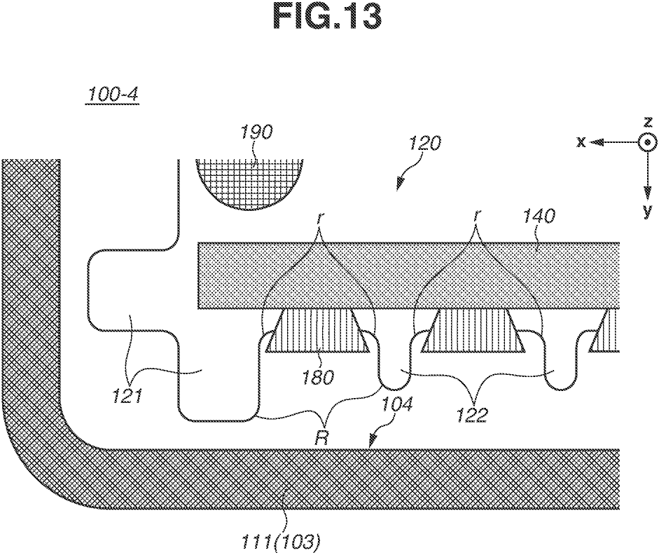

FIG. 13 is an enlarged view of a corner (e.g., a lower left corner) and its vicinity of the radiation imaging apparatus 100-4 according to the fourth exemplary embodiment of the present disclosure. Here, in FIG. 13, each configuration similar to the configuration illustrated in FIG. 1 and FIG. 2 is denoted by the same reference numeral as that in FIG. 1 and FIG. 2. In addition, FIG. 13 illustrates an xyz coordinate system corresponding to the xyz coordinate system illustrated in FIG. 1 and FIG. 2.

In the radiation imaging apparatus 100-4 according to the fourth exemplary embodiment, as illustrated in FIG. 13, at a corner convex portion 121 and a side convex portion 122, each corner of a surface end facing an inner wall 104 of an outer casing 111 forming a side wall portion 103 of a housing 110 has a curved shape as indicated by an R-portion. In a case where the corner of the surface end of each of the corner convex portion 121 and the side convex portion 122 has an angular shape as in the first to third exemplary embodiments described above, an impact received in a drop or a stress generated by vibration during work concentrates on this corner, so that this corner and the side wall portion 103 of the housing 110 can be worn out. In the present exemplary embodiment, the corner of the surface end of each of the corner convex portion 121 and the side convex portion 122 has a curved shape as indicated by the R-portion in FIG. 13, so that a stress generated by a drop impact is dispersed, and abrasion of the corner and the side wall portion 103 of the housing 110 can be thereby avoided. The R-portion illustrated in FIG. 13 may have, for example, an obtuse angle shape formed by chamfering (not illustrated), instead of having the curved shape. Forming the obtuse angle shape in this way also disperses a stress generated by a drop impact, so that abrasion of the corner of the surface end of each of the corner convex portion 121 and the side convex portion 122 and the side wall portion 103 of the housing 110 can be avoided.

Further, in the radiation imaging apparatus 100-4 according to the fourth exemplary embodiment, in the corner convex portion 121 and the side convex portion 122, the corner of a root portion projecting from the support base 120 has a curved shape as indicated by an r-portion, as illustrated in FIG. 13. In a case where the corner of the root portion projecting from the support base 120 in each of the corner convex portion 121 and the side convex portion 122 has a right angle or acute angle, a stress generated by an impact received in a drop concentrates on this corner, and this corner can be damaged. In the present exemplary embodiment, the corner of the root portion projecting from the support base 120 in each of the corner convex portion 121 and the side convex portion 122 has a curved shape as indicated by the r-portion illustrated in FIG. 13, so that a stress generated by a drop impact is dispersed, and damage to this corner can be thereby avoided. The r-portion illustrated in FIG. 13 may have, for example, an obtuse angle shape (not illustrated), instead of having the curved shape. Forming the obtuse angle shape in this way also disperses a stress generated by a drop impact, so that damage to the corner of the root portion projecting from the support base 120 in each of the corner convex portion 121 and the side convex portion 122 can be avoided.

Each of the above-described exemplary embodiments of the present disclosure is only a specific example for carrying out the present disclosure, and the technical scope of the present disclosure is not to be interpreted by these exemplary embodiments in a limited manner. In other words, the present disclosure can be implemented in various forms without departing from the technical spirit or major features thereof.

According to the exemplary embodiments of the present disclosure, it is possible to provide a radiation imaging apparatus that can protect an internal radiation detector, by efficiently absorbing and dispersing an impact in a limited inner space, when a housing receives the impact from outside.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2021-199304, filed Dec. 8, 2021, which is hereby incorporated by reference herein in its entirety.

What is claimed is:

1. A radiation imaging apparatus comprising:
a radiation detector configured to detect radiation and convert the detected radiation into an electrical signal relating to a radiation image;
a support base having a rectangular shape and supporting the radiation detector; and
a housing accommodating the radiation detector and the support base,
wherein the support base includes a plurality of protrusions extending from each side of an outer edge in the rectangular shape toward an inner wall of the housing, and
wherein, at an end of a first protrusion located at a corner in the rectangular shape among the plurality of protrusions, a distance to the inner wall of the housing is shorter than at an end of a second protrusion located at a position other than the corner.

2. The radiation imaging apparatus according to claim 1, wherein an amount of projection of the first protrusion from the support base is larger than an amount of projection of the second protrusion from the support base.

3. The radiation imaging apparatus according to claim 1, wherein, of the inner wall of the housing, a part near the first protrusion projects toward the first protrusion.

4. A radiation imaging apparatus comprising:
a radiation detector configured to detect radiation and convert the detected radiation into an electrical signal relating to a radiation image;
a support base having a rectangular shape and supporting the radiation detector; and
a housing accommodating the radiation detector and the support base,
wherein the support base includes a plurality of protrusions extending from each side of an outer edge in the rectangular shape toward an inner wall of the housing, and
wherein, among the plurality of protrusions, a first protrusion located at a corner in the rectangular shape has rigidity greater than rigidity of a second protrusion located at a position other than the corner.

5. The radiation imaging apparatus according to claim 4, wherein, in the first protrusion, an area of a surface facing the inner wall of the housing is larger than in the second protrusion.

6. The radiation imaging apparatus according to claim 4, wherein a material of the first protrusion is more rigid than a material of the second protrusion.

7. The radiation imaging apparatus according to claim 1, wherein the support base supports the radiation detector, on a side where a rear surface opposite to an incidence surface on which the radiation is to be incident is located in the housing.
